(19) United States
(12) Patent Application Publication
(10) Pub. No.: US 2002/0050505 A1
(43) Pub. Date: May 2, 2002

(54) Driving piston for a setting tool

(76) Inventor: Ulrich Rosenbaum, Wangs (CH)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 09/910,149

(22) Filed: Jul. 20, 2001

(30) Foreign Application Priority Data
Jul. 24, 2000 (DE) 100 35 845.4

(51) Int. Cl. B25C 1/14

(52) U.S. Cl. 227/10

(57) ABSTRACT

A driving piston for a high pressure gas-driven setting tool and including a sealing portion (1); and a shaft portion (2) adjoining the sealing portion (1) in the setting direction of the setting tool and having a diameter smaller than a diameter of the sealing portion (1), the shaft portion (2) being formed of a second section (4) adjoining the sealing portion (1) and a first section (3) adjoining the second section (4) and having a compression resistance greater than a compression resistance of the second section (4).

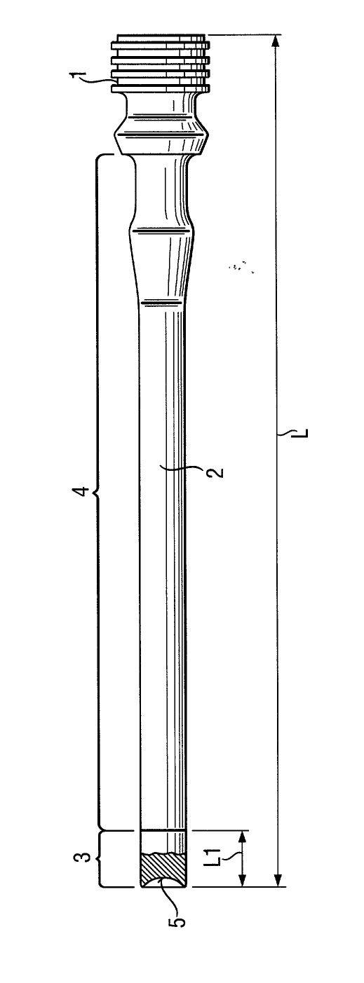

### BACKGROUND OF THE INVENTION

1. Field of the Invention

The present invention relates to a driving piston for a setting tool, in particular a high pressure gas-driven setting tool, and including a sealing portion, and a shaft portion adjoining the sealing portion in the setting direction of the setting tool and having a diameter smaller than a diameter of the sealing portion, with the shaft portion being formed of a second section adjoining the sealing portion and first section adjoining the second section.

2. Description of the Prior Art

For driving fastening elements in hard constructional components which are formed of concrete, stone, steel, setting tools, which include the above-described driving piston displaceable in a guide cylinder of the setting tool, are used.

During a setting process, during which a fastening element is driven into a constructional component, the driving piston is displaced in the setting direction with high speed under action of a high-pressure propellant gas until the end surface of the shaft portion, which faces in the setting direction, strikes the to-be-driven-in fastening element, transmitting to the fastening element its kinetic energy. Because of the high surface pressure acting on the end surface of the shaft portion and the high hardness of the to-be-driven-in fastening element, the shaft portion of the driving piston prematurely fails because of deformation or breaking.

Accordingly, object of the present invention is to provide a driving piston for a setting tool the shaft portion of which would have a very high compression resistance and cross-sectional strength so that a large number of setting processes can be effected with the driving piston, without the deformation of the setting direction end region of the driving piston and without of its noticeable wear.

### SUMMARY OF THE INVENTION

This and other objects of the present invention, which will become apparent hereinafter, are achieved by providing a driving piston of the above-described type and in which the shaft portion has a compression resistance greater than the compression resistance of the sealing portion.

A driving piston according to the present invention is capable of meeting different requirements of a setting process due to the fact that the shaft section adjoining the sealing portion, which adjoins the sealing portion adjoining shaft portion, has very high compression resistance and cross-sectional strength.

The compression resistant of the first shaft section preferably should exceed 2,300 N/mm². Such compression resistance noticeably reduces the deformation and wear of the first shaft section.

In order to be able to insure that the second, adjacent to the shaft sealing portion, section has a high flexural resistance, the second section is formed of a quenched steel which has a compression resistance amounting to about 2,000 N/mm². An increased compression resistance and, thereby, the reduced wear and deformation of the first section are achieved by forming the first shaft section of a tool steel. The compression resistance of a tool steel amounts to, e.g., about 3000 N/mm². Thus, the compression resistance of the material the first shaft section is made of is noticeably greater than the compression resistance of the material the second section is made of. With the steel quality being increased by the use of powder metallurgy, in addition, the cross-sectional strength, which is an essential characteristic, is greatly increased.

Preferably, the first shaft section is formed of a hard metal that is very had, wear-resistant, sufficiently ductile, and little sensitive to heat. The hard metals are produced by sintering of tempered, high-melting tungsten, molybdenum, tantalum, and titanium carbides with cobalt as a binding metal. The hard metal can have a compression resistance of up to 5,000 N/mm². Advantageously, the compression resistance of the first shaft section lies in the range from about 3,000 N/mm² to about 3,500 N/mm².

For manufacturing reasons, the length of the first shaft region varies from 3 to 20 mm.

The driving piston is guided in the setting tool by its sealing and shaft portions, with the shaft portion extending through a support the bore of which has an inner diameter corresponding to the outer diameter of the shaft portion. In order to increase the axial displacement path of the driving piston, care is taken to have the first shaft section also contribute to guiding of the driving piston in the setting tool. To this end, both the first and second shaft sections are formed with the same diameter. However, it is generally possible to so form the shaft portion that the diameter of the first section is smaller or larger than the diameter of the second shaft section.

Welding of the first shaft section to the second shaft section provides for a particular economical connection of the first shaft section with the second shaft section. However, both shaft sections can be connected by a combination of welding and soldering, or they can be releasably formlockingly connected.

The head of a fastening element, which falls in a direction opposite to the setting direction can e.g., have a convex bulge. In order to be able to transmit the drive energy of the driving piston to the fastening element without a noticeable loss, the setting direction end surface of the shaft section can be provided with a corresponding concave profile.

The novel features of the present invention, which are considered as characteristic for the invention, are set forth in the appended claims. The invention itself, however, both as to its construction and its mode of operation, together with additional advantages and objects thereof, will be best understood from the following detail description of preferred embodiments, when read with reference to the accompanying drawings.

### BRIEF DESCRIPTION OF THE DRAWINGS:

Single FIGURE of the drawings show a side view of the driving shaft for a setting tool according to the present invention.

### DETAILED DESCRIPTION OF THE PREFERRED EMBODIMENT

A driving piston according to the present invention, which is shown in the drawing, has a total length L and includes a sealing portion 1 and a shaft portion 2 which adjoins the sealing portion 1 in the setting direction of a setting tool in which the driving piston is to be used. The shaft portion 2 has a diameter which is smaller than the diameter of the sealing portion 1. The shaft portion 2 is formed of arranged one after another in the setting direction, first and second sections 3 and 4. Both first and second sections 3 and 4 have substantially the same diameter but different lengths. The first section has 3 has a length L₁, from about 3 mm to about 20 mm and, preferably, of about 10 mm which is substantially smaller than the length of the second section 4.

Advantageously, the second section 4 of the shaft portion 2 is formed as a one-piece part with the sealing portion 1, with the first section 3 of the shaft portion 2 being connected with the second section 4 by welding. The second section 4 is usually formed of quenched steel and is characterized by a high flexural stiffness. The first section 3 is preferably formed of a hard metal, e.g., a tool steel and has a compression resistance of more than 3000 N/mm². The free end surface 5 of the first section 3 has a concave recess.

Though the present invention was shown and described with references to the preferred embodiment, such are merely illustrative of the present invention and are not to be construed as a limitation thereof, and various modifications of the present invention will be apparent to those skilled in the art. It is, therefore, not intended that the present invention be limited to the disclosed embodiment or details thereof, and the present invention includes all variations and/or alternative embodiments within the spirit and scope of the present invention as defined by the appended claims.

What is claimed is:

1. A driving piston for a high pressure gas-driven setting tool, comprising a sealing portion (1); and a shaft portion (2) adjoining the sealing portion (1) in the setting direction of the setting tool and having a diameter smaller than a diameter of the sealing portion (1), the shaft portion (2) being formed of a second section (4) adjoining the sealing portion (1) and a first section (3) adjoining the second section (4) and having a compression resistance greater than a compression resistance of the second section (4).

2. A driving piston according to claim 1, wherein the compression resistance of the first section (3) exceeds 3000 N/mm².

3. A driving piston according to claim 1, wherein the first section is formed of a tool steel.

4. A driving piston according to claim 1, wherein the first section (3) is formed of a hard metal.

5. A driving piston according to claim 1, wherein the first section (3) has a length of (L₁) that amounts from 3 mm to 20 mm.

6. A driving piston according to claim 1, wherein the first and second sections (3, 4) have a substantially same diameter.

7. A driving piston according to claim 1, wherein the first and second sections (3, 4) are connected with each other by welding.

8. A driving piston according to claim 1, wherein a free end surface of the first section has a concave profile.
